(19) United States
(12) Patent Application Publication
(10) Pub. No.: US 2016/0114196 A1
(43) Pub. Date: Apr. 28, 2016

(54) Spare Cylinder Pack

(71) Applicant: Ralph Antoine Tribble, Lexington, KY (US)

(72) Inventor: Ralph Antoine Tribble, Lexington, KY (US)

(21) Appl. No.: 14/919,076

(22) Filed: Oct. 21, 2015

Related U.S. Application Data
(60) Provisional application No. 62/067,498, filed on Oct. 23, 2014.
(60) Provisional application No. 62/146,528, filed on Apr. 13, 2015.

(51) Int. Cl. A62B 9/04; A62B 9/02

(52) U.S. Cl. CPC A62B 9/04; A62B 9/02

(57) ABSTRACT

A spare cylinder carrying pack which includes holding sleeves for holding the spare air cylinders and straps for carrying the pack. In one configuration the straps are shoulder straps for carrying the spare cylinder pack on the shoulders. There is a separator panel between two holding sleeves. The separator panel allows the carrying pack to be worn by a firefighter or other first responder that is wearing a self-contained breathing apparatus (SCBA) that includes a cylinder worn on the back. The separator panel allows the two holding sleeves to sit on either side of the SCBA cylinder. The holding sleeves are configured to hold compressed air cylinders but can hold other equipment as well.

### CROSS REFERENCE TO RELATED APPLICATIONS

This application claims priority to U.S. provisional application Ser. No. 62/067,498, filed on Oct. 23, 2014, and to U.S. provisional application Ser. No. 62/146,528, filed on Apr. 13, 2015, and incorporated fully herein by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to pack that allows a firefighter or other first responder that is wearing a self-contained breathing apparatus (SCBA) to carry additional cylinders or other equipment.

2. Description of the Related Art

Firefighters and other first responders often wear self-contained breathing apparatus (SCBA) when they respond to a fire or other hazardous situation where there may be limited air to breath, or where the presence of toxins in the air would make it unsafe to breathe. For example it is very common for firefighters to wear the SCBA when inside a burning building filled with smoke. The SCBA consists of a compressed air tank, often referred to simply as a cylinder, that is worn on a pack on the back, a control valve on the cylinder that allows the user to control the flow of air from the tank, a face mask that covers the face, and a hose that connects the air tank to the face mask to deliver oxygen or clean air for breathing.

One of the difficulties encountered when wearing the SCBA in an emergency situation is that it is often necessary to carry additional equipment. For example it is not uncommon for firefighters to be inside a multi-story building and have to carry equipment up many flights of stairs. Often in these situations there is also a need to carry equipment from outside to a staging area inside the building. In some cases the staging area may be up many flights of stairs, or long distances from the outside of the building. In some situations, where it is anticipated that the firefighters may be inside a large building for an extended period of time, multiple air cylinders are brought to the staging area for later use. This means that a firefighter, wearing full protective gear and the SCBA, will have to carry equipment and additional cylinders to the staging area. This is commonly done in a few different ways. In some situations the firefighter will simply carry the additional cylinders by gripping the valve mechanism at the top, or holding the cylinder under the arm. Another method is to tie the cylinder tanks and equipment with ropes and slinging the rope over the shoulder to carry the equipment. The current methods leave the carried cylinders in an unstable manner which requires that the first responder use one or more hand to hold the cylinder steady. This means that the firefighter will not have both hands available, which can create a dangerous situation. There is a need, therefore, for a means for carrying spare cylinders and other equipment when a person is wearing the SCBA.

### SUMMARY OF THE INVENTION

The invention consists of a spare cylinder pack that can be worn over an existing SCBA. The spare cylinder pack has two cylinder holding sleeves that are sized and configured to hold a conventional compressed air cylinder, and a central separator panel between the two sleeves that is sized to fit over the cylinder of the SCBA. The spare cylinder pack has conventional shoulder straps and chest strap. The carrying pack is worn over the shoulders and fits over the cylinder of the SCBA with the two carrying sleeves on either side SCBA cylinder.

There are a number of alternate embodiments of the present invention. In the first alternate embodiment the separator panel is replaced with a cylinder holding sleeve, which allows three cylinders to be carried in the pack. In this embodiment the first responder wearing the pack can use one of the cylinders to provide air for the SCBA. In an alternate embodiment the shoulder strap and chest strap is replaced by a side carrying strap that allows the cylinders to be slung over one shoulder.

### BRIEF DESCRIPTION OF THE DRAWINGS

FIG. 1 is a perspective view of the prior art self-contained breathing apparatus SCBA.

FIG. 2 is a rear perspective view of the invention

FIG. 3 is a front perspective view of the invention.

FIG. 4 is a rear view of the invention worn over an SCBA.

FIG. 5 is a front view of the invention worn by a firefighter.

FIG. 6 is a rear view of an alternate embodiment the invention.

FIG. 7 is a rear view of a second alternate embodiment the invention.

### DETAILED DESCRIPTION OF THE INVENTION

Detailed embodiments of the present invention are disclosed herein. It is to be understood that the disclosed embodiments are merely exemplary of the invention, and that there may be a variety of other alternate embodiments. The figures are not necessarily to scale, and some features may be exaggerated or minimized to show details of particular components. Therefore, specified structural and functional details disclosed herein are not to be interpreted as limiting, but merely as a basis for teaching one skilled in the art to employ the varying embodiments of the present invention.

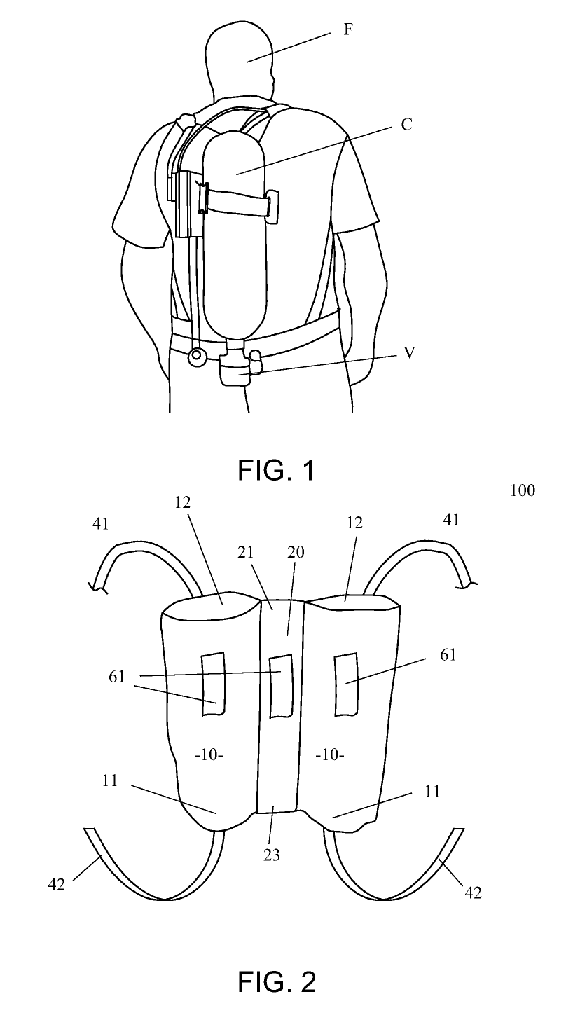

FIG. 1 is a perspective view of a typical self contained breathing apparatus (SCBA) worn by firefighters and other first responders F. The SCBA consists of a cylinder C for holding compressed air, a valve V on the cylinder that opens and closes the cylinder, a supply hose that supplies air from the tank, a regulator that controls the flow of air to the face mask, an air hose that supplies air from the regulator to the face mask, and a face mask. The SCBA is attached to the body by means of shoulder straps worn over the shoulders, and a chest strap between the shoulder straps to secure the SCBA. This type of SCBA is often worn in situations of limited air supply, such as in a burning or smoky building. The firefighter has both hands free and can use firefighting equipment while wearing the SCBA.

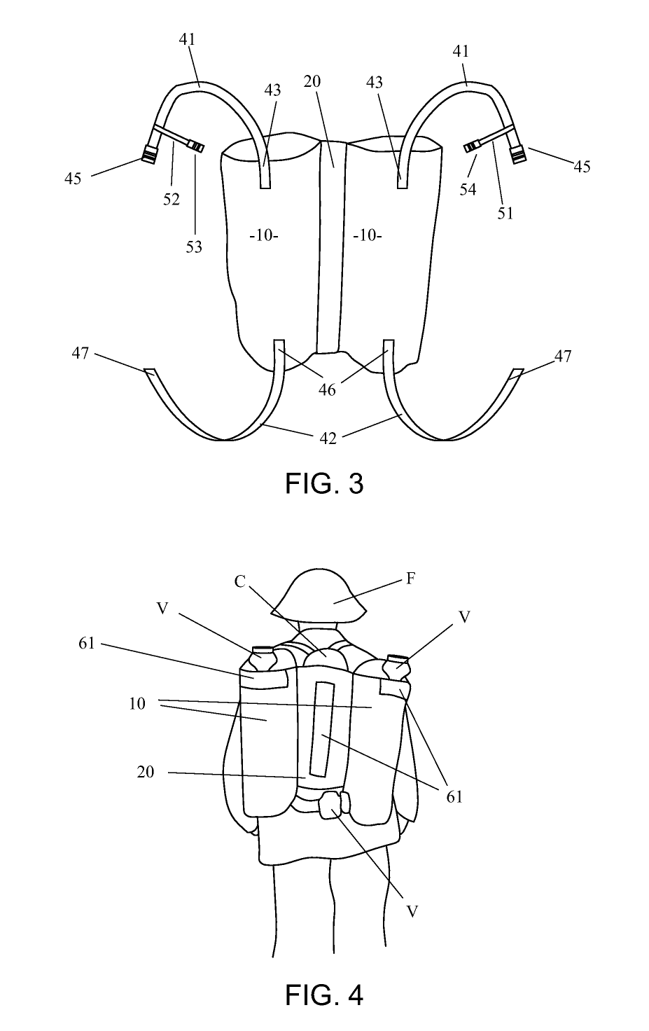

FIG. 2 and FIG. 3 are a front and rear view of the preferred embodiment of the spare cylinder pack 100, which consists of two holding sleeves 10 and a central separator panel 20. There are also shoulder straps 40 and a chest strap 50 that are attached to the spare cylinder pack 100 and allow the spare cylinder pack 100 to be carried on the shoulders like a backpack. In the preferred embodiment the spare cylinder pack 100 is made of a strong tight weave canvas fabric that is designed to withstand the forces involved in the use of such equipment. Heavy duty cotton canvas is the preferred material since cotton canvas can withstand the high temperatures present during a fire, and synthetic nylon can often melt at high temperatures. But it is possible, and within the conception of the invention, to manufacture the spare cylinder pack 100 from any suitably strong, durable, and fire and heat resistant material. One such material is commonly used for modern fire-hoses, and is made of a cotton material with synthetic materials such as polyester or nylon to improve the strength and durability of the carrying pack 100.

The two holding sleeves 10 are sized to hold a standard SCBA compressed air cylinder. Cylinders are typically about 21 inches in length without the valve, and about 24 inches in length with the valve. The diameter of cylinders vary depending upon the manufacturer and the internal air pressure, but standard cylinders have a diameter in inches that vary from roughly 6¼ inches to roughly 7 inches. The diameter of the holding sleeve 10 can be sized to hold specific cylinders, and hence have an internal diameter just slightly larger than the external diameter of the cylinder. Or the holding sleeve 10 can be sized to hold a variety of cylinders C of different diameters, and have an internal diameter of 7 inches. In the preferred embodiment the holding sleeve 10 is 15 inches long, from top to bottom, with a 7½ inch internal diameter.

The holding sleeve 10 is constructed of a sheet of durable material with one end sewn onto the other end to create the cylindrical holding sleeve 10. The sleeve bottom 11 is closed or partially closed. In the preferred embodiment the sleeve bottom 11 is partially closed by means of a piece of material sewn across the bottom. In one alternate embodiment the sleeve bottom 11 is only partially closed with a piece of material with a circular hole which allows the cylinders to be placed in the holding sleeve 10 upside down, with the valve V extending through the hole in the partially closed bottom. In embodiments with the sleeve bottom 11 completely closed the holding sleeve 10 can be used to transport a variety of items other than air cylinders. In another embodiment the sleeve bottom is partially closed by a strip of material sewn across the opening.

In the preferred embodiment the sleeve top 12 is open, and not closeable. When in use, with the spare cylinder pack 100 on a first responder's back, the holding sleeve 10 is in the vertical position with the sleeve top 12 at the top of the holding sleeve 10. Because of the weight of the cylinder, the cylinders carried in the holding sleeve 10 will not easily or readily come out of the holding sleeve 10, so there is no need to enclose the sleeve top 12. In an alternate embodiment the sleeve top 12 is closeable by means of a top flap 13. The top flap 13 is made from the same material as the body of the holding sleeve 10. In the preferred embodiment the top flap 13 is a piece of material roughly six inches wide and roughly twelve inches long. One end of the top flap 13 is sewn onto the holding sleeve 10 adjacent to the sleeve top 12. There is a strip 14a of Velcro® at the other end of the top flap 13. There is a paired strip of Velcro® 14a sewn onto the holding sleeve 10 adjacent to the sleeve top 12. This allows the top flap 13 to be closed and secured over anything carried within the holding sleeve 10.

There is a central separator panel 20 that is attached between the two holding sleeves 10. In the preferred embodiment the separator panel 20 is attached to the two sleeves 10 by means of sewing. The separator panel has a top edge 21, a bottom edge 23, a right edge 22 and a left edge 24. The left edge 22 and right edge 24 are attached to the two holding sleeves 10. In the preferred embodiment the separator panel 20 is 15 inches long from the top edge 21 to the bottom edge 23, and 7½ inches wide from the right edge 22 to the left edge 24. It is possible and within the conception of the invention, for these dimensions to vary as the size and type of the spare cylinders C vary. It is possible to attach the separator panel 20 between the sleeves 10 by other durable means such as well known fabric rivets. Because the spare cylinder pack 100 is used in extreme environments while carrying a considerable amount of weight, the components are sewn with heavy duty threads and multiple stitching to ensure the components remain attached.

As best seen in FIG. 3, There are two shoulder straps 40 that allow the spare cylinder pack 100 to be carried on the shoulders of a firefighter or first responder like a backpack. The shoulder straps 40 are made of standard strap material, and are both the same. In the preferred embodiment the shoulder straps 40 are approximately two inches wide and made of heavy duty cotton canvas. The shoulder straps 40 can be made from any suitable durable and heat resistant material. The shoulder strap 40 has a top strap 41 and a bottom strap 42. The top strap 41 has an attached end 43 and an adjustment end 44. The attachment end 43 is attached to the front of the sleeve top 12, typically by sewing, though they can be attached by rivets or other durable means. The bottom strap 42 has an attachment end 46 and an adjustment end 47. The attachment end 46 is attached to the front of the sleeve bottom 11, typically by sewing. There is a strap adjuster 45 attached to the adjustment end 44 of the top strap 41. The strap adjuster 45 is a standard strap adjuster having three slots, and such strap adjusters are well known in the art. The adjustment end 44 of the top strap 41 is run through the top slot and secured. In the preferred embodiment the adjustment end 44 is run through the top slot and then sewn onto itself to secure the strap adjuster 45 to the adjustment end 44 of the top strap 41. The attachment end 46 of the bottom strap 42 is run through the bottom slot then the middle slot to create a secure but adjustable attachment. When the spare cylinder pack 100 is worn the shoulder straps 40 can be synched tight by pulling down on the adjustment end 47 of the bottom strap 42.

There is a chest strap 50 attached between the two shoulder straps 40 to secure the spare cylinder pack 100 onto the wearer and ensure that it cannot easily come off. The chest strap 50 consists of a left chest strap 51 and a right chest strap 52 and a buckle assembly 55. The left chest strap 51 is attached to the top strap 41 of the left shoulder strap 40, commonly by means of sewing, though other durable attachment means such as riveting can be used. The right chest strap 52 is attached to the top strap 41 of the right should strap 40, in the same manner as the left chest strap 51. The buckle assembly 55 is a standard seat belt buckle with a tongue 53 and a buckle 54 with a large release button 59. The large release button 59 allows for the easy opening of the buckle assembly 55 in smoky or low visibility environments. The tongue 53 is attached to the left chest strap 51, typically by sewing, and the buckle 54 is attached to the right chest strap 52, by sliding the right chest strap 52 through the attachment loop of the buckle 54, which allows the buckle 54 to be tightened when attached. The tongue 53 slides into the buckle 54 and snaps into place. The buckle assembly 55 can be any standard strap buckle assembly, which are well known in the art.

In the preferred embodiment there is reflector tape 61 sewn onto the back of the two cylinders 10 and the separator panel 20. Such reflector tape is common on firefighting equipment and allows firefighters to see each other in the smoky and low light environments inside a building during a fire.

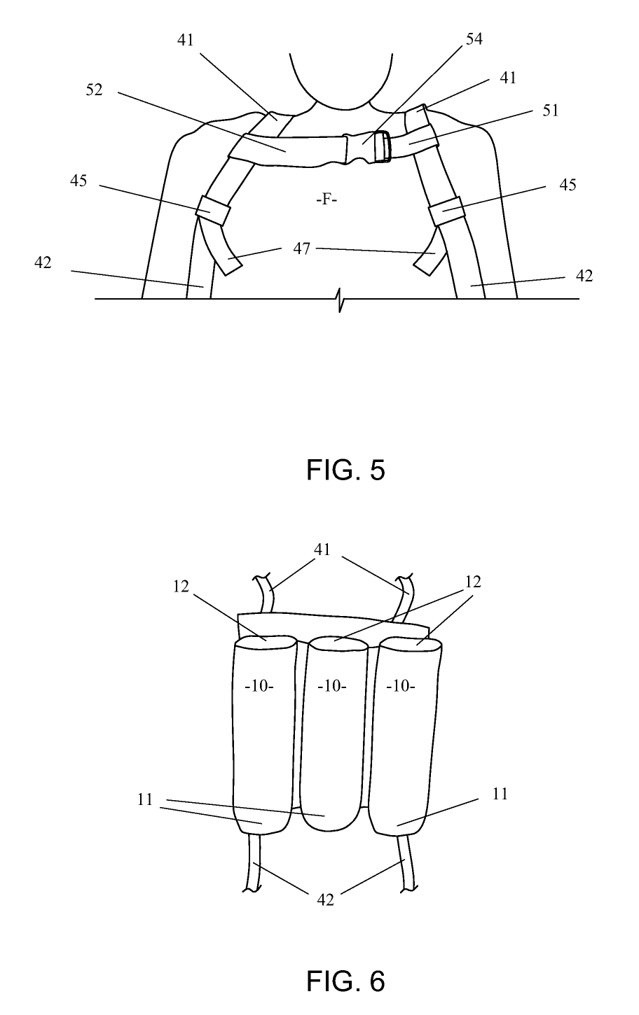

In use, spare cylinders C are placed in each of the two holding sleeves 10, and the spare cylinder pack 100 is pulled up over the shoulders by means of the shoulder straps 40. In most situations this will be done with the assistance of another person, since the spare cylinder pack 100 will be worn over the standard SCBA, and the firefighter will have limited mobility. The central separator panel 20 is sized and space to allow the two cylinders in the holding sleeves 10 to be positioned on either side of the SCBA cylinder C that the firefighter is already wearing. This is shown in FIG. 4 and FIG. 5. When the spare cylinder pack 100 is over the shoulders the firefighter F will be able to adjust the shoulder straps 40 by pulling down on the adjustment ends 47 to secure the spare cylinder carrying pack 100 onto the shoulders, and then will snap the tongue 53 into the buckle 54 of the chest strap 50 to ensure that the shoulder straps 40 cannot slide off the wearer's shoulders. This leaves the firefighters hands free during the transport of the spare cylinders. This allows the firefighter to potentially use other firefighting equipment. When the firefighter arrives at the staging area the spare cylinder carrying pack 100 can easily be removed by unlatching the buckle assembly 55 by pressing the buckle 54, and then by loosening the shoulder straps 40 by means of the strap adjuster 45. Once loose the firefighter can easily slip one shoulder out of the shoulder straps 40 and remove the spare cylinder carrying pack 100 and then remove the cylinders or other equipment.

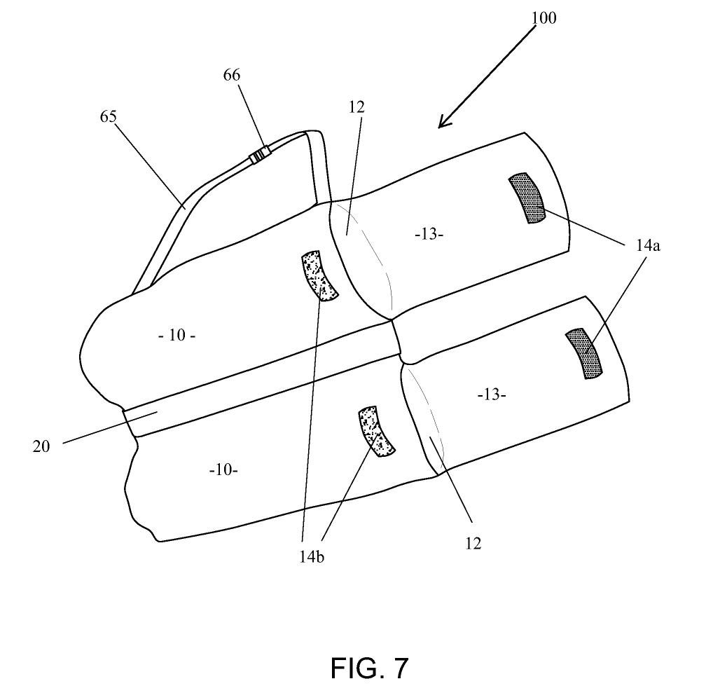

In an alternate embodiment of the invention, shown in FIG. 6, the separator panel 20 is replaced by a third holding sleeve 10, which will mean that the spare cylinder pack 100 can hold three air cylinders C. In this configuration it is possible for the firefighter to use one of the three air cylinders with the SCBA. It is also possible to use this configuration in situations where compressed air for breathing is not initially needed, but the firefighter needs to transport a large number of air tanks, or other equipment, to the staging area.

In a second alternate embodiment of the invention, shown in FIG. 7, the shoulder straps are replaced by a single carrying strap 65 that attaches to one of the holding sleeves 10. One end of the carrying strap 65 is attached near the side top 12 of one of the holding sleeves 10 and the other end is attached near the bottom 11 of the same holding sleeve 10. There is also a strap adjuster on the carrying strap 65 to allow the adjustment of the length of the carrying strap 65. This will allow the spare cylinder pack 100 to be slung over a single shoulder. In one variation of this embodiment the separator panel 20 is much narrower since it does not need to fit over the cylinder of the SCBA. The top flap 13 is particularly important in this embodiment since the holding sleeves 10 are not carried in the vertical position so it is possible for the spare cylinders C, or other items, to fall out if the top 11 is not closed. The top flap 13 includes a strip 14a of hook and loop material, with a paired strip 14b of hook and loop material sewn near the top 11 of the holding sleeve 10, which allows the top 11 to be closed to prevent equipment from falling out of the holding sleeve 10.

The present invention is well adapted to carry out the objectives and attain both the ends and the advantages mentioned, as well as other benefits inherent therein. While the present invention has been depicted, described, and is defined by reference to particular embodiments of the invention, such reference does not imply a limitation to the invention, and no such limitation is to be inferred. The depicted and described embodiments of the invention are exemplary only, and are not exhaustive of the scope of the invention. Consequently, the present invention is intended to be limited only be the spirit and scope of the claims, giving full cognizance to equivalents in all respects.

I claim:

1. A spare cylinder pack for carrying spare cylinders, said spare cylinder pack comprising:
two cylindrical holding sleeves having an internal space sized to hold spare cylinders and an open top to allow the cylinders to be placed in the holding sleeves;
a separator panel attached between said holding sleeves; and
straps for carrying said spare cylinder holding pack.

2. The spare cylinder pack of claim 1 wherein said holding sleeves are as long as a standard air cylinder and have a diameter just slightly larger than the diameter of the standard air cylinder.

3. The spare cylinder pack of claim 2 wherein the holding sleeve is between 14 and 20 inches long and has a diameter of between five and one half and seven and one half inches.

4. The spare cylinder pack of claim 1 wherein said holding sleeves have an open top and a fully closed bottom.

5. The spare cylinder pack of claim 1 wherein said holding sleeves have an open top and a partially closed bottom.

6. The spare cylinder pack of claim 5 wherein said partially closed bottom is configured to accommodate a control valve of a cylinder to allow the spare cylinder to be carried upside down in said holding sleeve.

7. The spare cylinder pack of claim 1 wherein said straps for carrying consist of two shoulder straps to allow the spare cylinder pack to be carried on a wearer's shoulders.

8. The spare cylinder pack of claim 7 wherein said shoulder straps include strap adjusters to allow the adjustment of said straps to secure on the wearer's shoulders.

9. The spare cylinder pack of claim 7 wherein said shoulder straps further include an openable chest strap attached therebetween to allow the shoulder straps to be temporarily secured on a wearer's shoulders.

10. The spare cylinder pack of claim 1 wherein said straps for carrying consist of a single adjustable strap to allow the spare cylinder pack to be carried over one shoulder.

11. The spare cylinder pack of claim 10 wherein said holding sleeve further includes a closable top flap to secure the spare cylinder in the holding sleeve.

12. The spare cylinder pack of claim 1 wherein said separator panel is sized to allow said spare cylinder pack to be worn over a standard self-contained breathing apparatus having an air cylinder worn on the back, and with the two holding sleeves on either side of the air cylinder.

13. The spare cylinder pack of claim 12 wherein said separator panel is no less than seven inches wide such that the two holding sleeves sit on either side of the air cylinder of the self-contained breathing apparatus.

14. A spare cylinder pack that allows a person wearing a self-contained breathing apparatus having an air cylinder worn on the person's back to carry spare cylinders, said spare cylinder pack comprising:
two cylindrical holding sleeves, wherein said holding sleeves are open tubes made of durable fabric and having an open top and a partially closed bottom, and sized to hold a cylinder;
a separator panel attached between said holding sleeves, said separator panel a rectangular piece of durable material sewn on one side to one holding sleeve and on the opposite side to the second holding sleeve; and
straps for carrying said spare cylinder holding pack, including two adjustable shoulder straps for carrying the spare cylinder pack over the shoulders and a chest strap with a buckle for securing the spare cylinder pack;
wherein the separator panel allows the spare cylinder pack to be worn over a standard self-contained breathing apparatus with one holding sleeve on one side of the air cylinder and the other holding sleeve on the other side of the air cylinder.
